(19) United States
(12) Patent Application Publication
(10) Pub. No.: US 2007/0253767 A1
(43) Pub. Date: Nov. 1, 2007

(54) Dual shaft mechanism

(76) Inventors: Te-Hsin Chuang, Jhubei City (TW); Yao-Sheng Wu, Jhubei City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/414,268

(22) Filed: May 1, 2006

(51) Int. Cl. F16L 41/00

(52) U.S. Cl. 403/230

(57) ABSTRACT

A dual shaft mechanism includes a rotary base (10). The rotary base includes a first shaft seat (11) extending along a first axle (31) thereof, and a second shaft hole (13) extending along a second axle (32). The dual shaft mechanism further includes a first shaft (12) assembled with the first shaft seat, and a second shaft (14) sleeved by the second shaft hole. The second shaft is rotatable about the second axle.

### BACKGROUND OF THE INVENTION

1. Field of the Invention

The present invention relates to a dual shaft mechanism, especially to a dual shaft mechanism enabling high reliability and high intensity.

2. Description of the Related Arts

Various electrical devices are provided nowadays. And the manufacturers are involved in improving the functions of the devices for obtaining favor of the customers. Changing of the mechanism design of the device is also an important aspect.

In order to upgrade the character of an electrical device, such as a portable media player, a dual shaft mechanism can be applied to assembled with a screen thereof. The screen can not only rotate about one axle, but also rotate about another axle, which enables the customers to use the screen from multiple aspects. In order to realize the dual-axial-rotation-function, numerous components are needed, which affects the trend of reducing the cubage of the electrical device. At the same time, stability of the structure, intensity, serviceability can not be insured.

Accordingly, a new dual shaft mechanism, which enables high reliability, high intensity and excellent serviceability, is desired.

### SUMMARY OF THE INVENTION

A major object of the present invention is to provide a dual shaft mechanism enabling high reliability, high intensity and excellent serviceability.

According to the above-mentioned object, the present invention provides an improved dual shaft mechanism used in an apparatus. The dual shaft mechanism includes a rotary base. The rotary base comprises a first shaft seat extending along a first axle thereof, and a second shaft hole extending along a second axle. The dual shaft mechanism further includes a first shaft assembled with the first shaft seat, and a second shaft sleeved by the second shaft hole. The second shaft is rotatable about the second axle.

According to the above-mentioned invention, the first shaft includes a first fastening portion for assembling the first shaft with the apparatus, and a second fastening portion for assembling the first shaft with the first shaft seat. The second fastening portion is partially sleeved in the first fastening portion, which enables the rotary base to rotate about the first axle.

According to the above-mentioned invention, the first fastening portion is positioned in at least one whorled hole of the apparatus by at least one bolt, and the second fastening portion is locked in at least one whorled hole of the first shaft seat by at least one bolt.

According to the above-mentioned invention, the second axle is perpendicular to the first axle.

According to the above-mentioned invention, the rotary base is formed from ordinary plastic or engineering plastic, while the first shaft and the second shaft are formed from metal or instrumental steel.

According to the above-mentioned invention, the second shaft includes an installing hole seat at one end thereof for engaging with another device.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

The present invention will become more apparent from the following detailed description when taken in conjunction with the accompanying drawings, in which:

### BRIEF DESCRIPTION OF THE DRAWINGS

FIG. 1 is an exploded isometric view of a dual shaft mechanism in accordance with a preferred embodiment of the present inventions showing the mechanism to be assembled to an apparatus; and

FIG. 2 is an exploded isometric view of the dual shaft mechanism of FIG. 1.

### DESCRIPTION OF PREFERRED EMBODIMENT

Reference will now be made to the drawings to describe the present invention in detail.

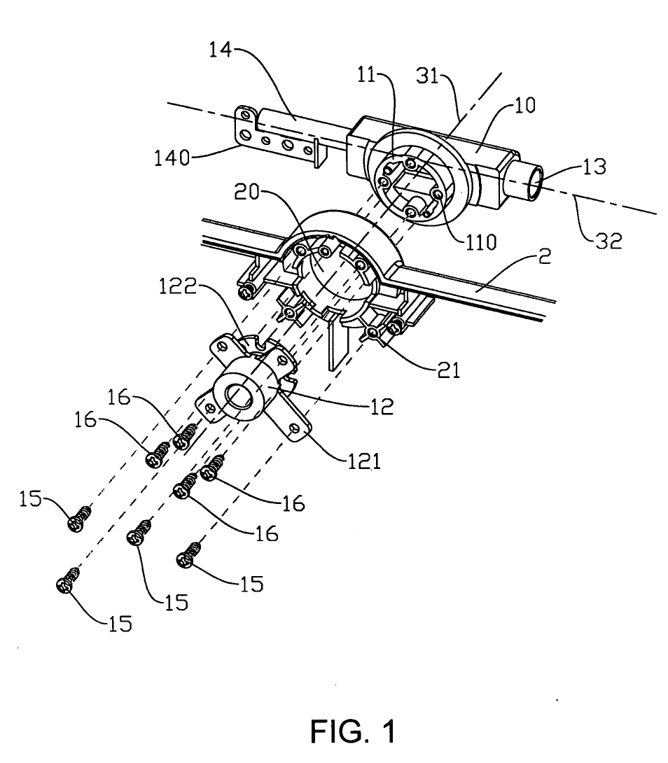

Referring to FIG. 1, which is an exploded isometric view of a dual shaft mechanism assembled with an apparatus in accordance with a preferred embodiment of the present invention, the dual shaft mechanism 1 includes a rotary base 10, a first shaft 12 and a second shaft 14. The rotary base 10 is assembled with the first shaft 12 and can rotate about a first axle 31 of the first shaft 12. The second shaft 14 is mounted with the rotary base 10 and can rotate about a second axle 32. Detailed structures of the mechanism are described hereinafter.

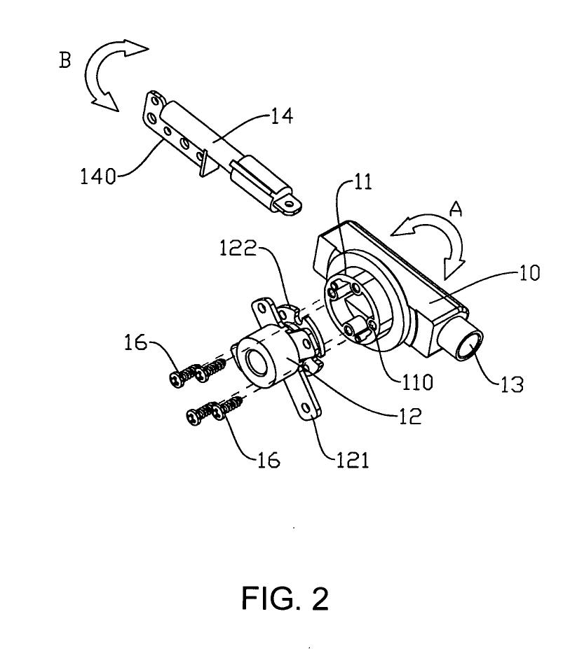

Referring to FIG. 1, the rotary base 10 defines a first shaft seat 11 along the first axle 31. It is better to provide the first shaft seat 11 with at least one whorled hole 110. The second shaft includes a first fastening portion 121 and a second fastening portion 122. The first fastening portion 121 is used for assembling the first shaft 12 with the apparatus 2. It is better to assemble the first fastening portion 121 with the apparatus 2 by virtue of cooperation between at least one bolt 15 and a whorled hole 21. Further, the second fastening portion 122 is used for engaging the first shaft 12 with the first shaft seat 11 by virtue of cooperation between at least one bolt 16 and the at least one whorled hole 110, via a through-hole 20 in the apparatus. The second fastening portion 122 is sleeved with the first fastening portion 121. Accordingly, the rotary base 10 can rotate about the first axle 31 relative to the apparatus 2. A rotating direction is shown as an arrow A in FIG. 2.

Returning to FIG. 1 again, the rotary base 10 define s a second shaft hole 13 along the second axle, and the second shaft 14 drills through the second shaft hole 13, which enables the second shaft to rotate about the second axle 32 relative to the rotary base 10. A rotating direction is shown as an arrow B in FIG. 2

In the above-described dual shaft mechanism 1, the rotation of the rotary base 10 about the first axle 31 and the rotation of the second shaft 14 about the second axle 32 can be realized individually and respectively. No interference exists between the two rotations. It's a better mode but not limited that the first axle 31 is perpendicular to the second axle 32.

The dual shaft mechanism 1 can be used in a media player (not shown). The mechanism 1 can enable the player to have a screen (not shown) having two rotary axles. The second shaft 14 can be provided with an installing hole seat 140 at one end thereof for engaging with the screen.

In addition, the rotary base can be made of plastic, especially engineering plastic, which enables the rotary base to be manufactured easily and to have excellent anti-attrition ability. The first and second shafts 12, 14 can be made of metal, especially instrumental steel. By cooperating between the shafts 12, 14 and the material of the rotary base 10, the dual shaft mechanism 1 is of high stability, high intensity and excellent serviceability.

Furthermore, although the present invention has been described with reference to particular embodiment, it is not to be construed as being limited thereto. Various alterations and modifications can be made to the embodiments without in any way departing from the scope or spirit of the present invention as defined in the appended claims.

What is claimed is:

1. A dual shaft mechanism used in an apparatus, comprising:
a rotary base defining a first shaft seat along a first axle, and a second shaft hole along a second axle;
a first shaft engaging with the first shaft seat via a through-hole of the apparatus; and
a second shaft drilling through the second shaft hole.

2. The dual shaft mechanism according to claim 1, wherein the first shaft comprises:
a first fastening portion, for assembling the first shaft with the apparatus; and
a second fastening portion for assembling the first shaft with the first shaft seat, wherein the first fastening portion is sleeved with the second fastening portion for enabling the rotary base to rotate about the first axle.

3. The dual shaft mechanism according to claim 2, wherein the first fastening portion is positioned in at least one whorled hole of the apparatus by at least one bolt.

4. The dual shaft mechanism according to claim 2, wherein the second fastening portion is locked in at least one whorled hole of the first shaft seat by at least one bolt.

5. The dual shaft mechanism according to claim 1, wherein the second shaft drills through the second shaft hole, which enables the second shaft to rotate about the second axle relative to the rotary base.

6. The dual shaft mechanism according to claim 1, wherein the second axle is perpendicular to the first axle.

7. The dual shaft mechanism according to claim 1, wherein the rotary base is formed from ordinary plastic.

8. The dual shaft mechanism according to claim 1, wherein the rotary base is formed of engineering plastic.

9. The dual shaft mechanism according to claim 1, wherein the first shaft is formed from metal.

10. The dual shaft mechanism according to claim 1, wherein the first shaft is formed from instrumental steel.

11. The dual shaft mechanism according to claim 1, wherein the second shaft is formed from metal.

12. The dual shaft mechanism according to claim 1, wherein the second shaft is formed from instrumental steel.

13. The dual shaft mechanism according to claim 1, wherein the second shaft defines an installing hole at one end thereof for engaging with another device.
